(19) United States
(12) Patent Application Publication
(10) Pub. No.: US 2014/0224935 A1
(43) Pub. Date: Aug. 14, 2014

(54) Aircraft Liquid Dispensing System

(71) Applicant: Richard J. Lazes, Cornelius, NC (US)

(72) Inventor: Richard J. Lazes, Cornelius, NC (US)

(21) Appl. No.: 13/766,614

(22) Filed: Feb. 13, 2013

(51) Int. Cl. B64D 1/00

(52) U.S. Cl. CPC B64D 1/18
USPC 244/136

(57) ABSTRACT

An aircraft liquid dispensing system is provided, comprising a flexible and collapsible reservoir positioned within a pressurized aircraft interior, wherein the reservoir is secured to the aircraft by a restraint assembly; a fill port located on the reservoir; a liquid control valve fluidically coupled to one end of the reservoir; a discharge tube fluidically connected between the liquid control valve and an exterior surface of the aircraft; and wherein the reservoir is adapted to collapse and release liquids contained therein responsive to a pressure differential between the aircraft interior and outside the aircraft.

### CROSS-REFERENCE TO RELATED APPLICATIONS

Not applicable.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### BACKGROUND OF THE INVENTION

1. Field of the Invention

The present invention relates to apparatuses used to dispense liquids from airplanes for the purposes of extinguishing forest fires, spraying insecticides, or spraying dispersant chemicals to break up oil slicks.

2. Description of Related Art

During the summer months or during droughts, heavily wooded areas are prone to forest fires. One of the biggest problems with wildfires is the inability to rapidly extinguish them because of the lack of access or absence of roads into such wooded areas. Thereby, the use of fire trucks equipped with water and/or chemicals deep into flaming wooded areas have proven to be futile in most cases. As a result, the use of aircraft to expel chemicals and/or water from high in the sky has been attempted with some success.

In order to be effective at extinguishing forest fires from airplanes it is essential to dispense large quantities of fire retardants in a short period of time in order to achieve high densities of these liquids on the ground. Conventional aerial tanker systems employ either barn door type dispensing systems or pressurized systems to achieve these high flow rates. These systems are expensive to build and maintain and produce inconsistent results.

The present invention is far simpler, more reliable and more effective than the prior art because it does not require large barn doors or large pumps. The present invention takes advantage of the existing pressurized cabins available in large jet aircraft. Since the liquid reservoir of the present invention is flexible it takes advantage of the internal cabin pressure that is created by the airplane's jet engines to flatten the flexible tank and force the fire retardant out of the outlet orifice under pressure. This generates high flow rates of the liquids as they are expelled from the tank and results in high densities of liquids when they hit the ground. Additionally, since there is no interphase between the pressurized cabin air and the liquids, there is no emulsification of the liquids thus resulting in a very dense and consistent flow pattern which is very effective at extinguishing fires.

This same apparatus is effective at dispensing oil spill dispersants on oil spills employing the same internal cabin pressure. In this application the outlet orifice is fitted with spray nozzles to create a misting type of spray pattern that is highly effective at dispersing oil spills.

Oil spills at sea cause significant environmental damage when they migrate to land. It is common to spray dispersant chemicals on floating oil spills in order to break up the oil slicks into tiny particles that are no longer buoyant. As these particles sink into the water column they are biodegradable. Oil dispersant can be sprayed from boats or airplanes on oil spills. The present invention relates to an apparatus that can be installed on airplanes for this purpose without the need for the installation of large fixed tanks, compressors and nozzles.

Several apparatuses have been patented which are aimed at aerial dispensing of chemicals or fire extinguishing agents via an aircraft.

U.S. Pat. No. 7,303,168, issued to Lazes, entitled “AIRCRAFT SPRAYING CONVERSION KIT FOR USE IN EXTINGUISHING FIRES” discloses a system for dispensing a fire extinguishing agent which includes a collapsible storage tank and a dispensing manifold integrated with the aircraft's cargo door.

U.S. Pat. No. 4,437,630, issued to Jefferies, entitled “SPRAY BOOM APPARATUS FOR APPLYING CHEMICAL DISPERSANTS TO OCEAN OIL SPILLS” discloses a self-contained spraying boom apparatus which is permitted to be extended from the cargo hold of a transport plane to a position outside of the plane's fuselage.

U.S. Pat. No. 4,195,693, issued to Busch et al., entitled “DEVICE FOR EXTINGUISHING FIRES FROM THE AIR” discloses a fire-extinguishing device which includes an inclined baffled tank in the fuselage adjacent and at a higher level than rearwardly opening door. The discharge pipe is swingably connected to the rear end of the tank. A valve in the discharge pipe is opened automatically when the door is opened.

U.S. Pat. No. 4,172,499, issued to Richardson et al, entitled “POWDER AND WATER MIXING AND DROPPING SYSTEM ONBOARD AN AIRCRAFT” discloses a powder and water mixing system which allows water from a body of water, such as a lake or river, to be scooped via scoops mounted on the bottom of the fuselage as the aircraft travels over the body of water. The water is mixed with a fire retardant powder in the aircraft.

U.S. Pat. No. 3,603,506, issued to Hubbs, entitled “UNIVERSAL CHEMICAL DELIVERY SYSTEM” discloses a system for dispensing chemicals from an airplane while in flight. The chemicals are stored in a collapsible or deflateable storage means removably positioned within the load space of the airplane. A spray nozzle assembly is detachably affixed to the wing or tail of the airplane for distributing the chemicals. Importantly, it does not rely on the internal airplane pressure to urge the fluids out of the storage means, and it fails to disclose an air tight connection between the outlet hose and the exterior surface of the airplane. Without an airtight connection, it would be impossible to maintain a pressurized interior of the aircraft, because the pressure would leak from the airplane.

U.S. Pat. No. 3,484,062, issued to Johnson, entitled “AERIAL DISPENSING APPARATUS” discloses an aerial crop dusting apparatus which includes a plurality of spaced ejector tubes extending along the wings of the plane for dispensing metered powder or granular material from a feed hopper or bin in the fuselage.

U.S. Pat. No. 2,493,017, issued to Nutter, entitled “GRID SPRAY NOZZLE” discloses a grid spray nozzle including a fluid manifold having a plurality of spray nozzle conduits or tube extending in parallel relation from the fluid manifold. The grid spray nozzle is attached to the underside of the fuselage.

U.S. Pat. No. 2,426,771, issued to Harp, entitled “AIRPLANE MOUNTED FIRE EXTINGUISHING APPARATUS” discloses an apparatus including tanks stored in the fuselage and a plurality of spaced nozzles coupled along the under face of the wings.

As can be readily seen, there is a continuing need for an aircraft spraying conversion kit that can be installed in a pressurized aircraft and which includes a flexible and collapsible fluid reservoir positioned within an aircraft connected to a valve directly coupled to one end of the fluid reservoir along with a dispensing tube that has one end fluidically coupled to the discharge end of the valve and the other end fluidically coupled to an outlet orifice that penetrates the outer skin of the aircraft.

### SUMMARY OF THE INVENTION

The preferred embodiment of the aircraft liquid dispensing device of the present invention solves the aforementioned problems in a straight forward and simple manner. What is provided is an aircraft liquid dispensing device which includes a flexible and collapsible fluid reservoir positioned within a pressurized aircraft connected to a valve directly coupled to one end of the fluid reservoir along with a dispensing tube that that has one end fluidically coupled to the discharge end of the valve and the other end fluidically coupled to an outlet orifice that penetrates the outer skin of the aircraft. This aircraft liquid dispensing device of the present invention takes advantage of an aircraft that has internally pressurized cabin which is used to flatten the flexible fluid reservoir and in doing so force the liquids out of the fluid reservoir when the valve is opened. The force of the cabin pressure serves to generate force on the flexible fluid reservoir and internal pressure on the fluid inside thus generating a pressurized stream of fluids when they exit the aircraft.

Broadly, the aircraft fluid dispensing system is installed in a pressurized airplane and comprises: a flexible and collapsible fluid reservoir for storing therein water, liquid fire extinguishing fluids, oil dispersing agents or herbicides; a valve couple to the outlet end of said reservoir, a dispensing conduit coupled to said valve; a dispensing manifold assembly coupled to said dispensing conduit. The dispensing manifold assembly comprises: an inlet port coupled to said dispensing conduit for receiving said liquids; at least one outlet orifice in fluid communication with said inlet port and which dispenses therefrom said liquid to the exterior of said aircraft.

In view of the above, it is an object of the present invention to provide an aircraft liquid dispensing system which is adapted for installation on most aircrafts such as cargo type aircrafts. Thereby, the need to maintain an aircraft specifically designated for fire extinguishing oil dispersant or herbicide spraying operations is eliminated.

Another object of the invention is to provide an aircraft liquid dispensing system which allows the aircraft to be quickly reconverted into a passenger or cargo carrying aircraft.

It is a further object of the present invention to provide an aircraft liquid dispensing system which provides for the direct application of a fire extinguishing agent over a large area of a wildfire as the aircraft travels over such wildfire.

In view of the above objects, it is a feature of the present invention to provide an aircraft liquid dispensing system which is relatively simple to install.

Another feature of the present invention is to provide an aircraft liquid dispensing system which is relatively simple structurally and thus simple to manufacture.

The above and other objects and features of the present invention will become apparent from the drawings, the description given herein, and the appended claims.

### BRIEF DESCRIPTION OF THE DRAWINGS

For a further understanding of the nature, objects, and advantages of the present invention, reference should be had to the following detailed description, read in conjunction with the following drawings, wherein like reference numerals denote like elements.

FIG. 1 illustrates a sectional view of the cargo bay of a pressurized aircraft equipped with a flexible and collapsible fluid reservoir of the present invention, filled with liquid and installed in the cargo bay of the aircraft.

FIG. 2 illustrates an exterior view of the aircraft with the outlet orifice of the present invention connected to the skin of the aircraft with an air tight connection.

FIG. 3 illustrates a sectional view of an alternate embodiment of the present invention wherein the aircraft is equipped with two flexible and collapsible fluid reservoirs fluidically connected together with a dispensing manifold, which is connected to a dispensing tube which is in turn coupled to an air tight connection in the outer skin of the airplane.

FIG. 4 illustrates a perspective view of the rigid tube restrain system installed around the two flexible fluid reservoirs to prevent them from moving around during flight.

FIG. 5 illustrates another alternate embodiment of the present invention incorporating multiple outlet orifices installed in the outer skin of the airplane.

FIG. 6 illustrates an exterior view of the aircraft with the multiple outlet orifices of the present invention connected to the skin of the aircraft with an air tight connection.

FIG. 7 illustrates a sectional view of the cargo bay of a pressurized aircraft equipped with a flexible and collapsible fluid reservoir of the present invention, in its collapsed and empty state and installed in the cargo bay of the aircraft.

### DETAILED DESCRIPTION OF THE INVENTION

Before the subject invention is further described, it is to be understood that the invention is not limited to the particular embodiments of the invention described below, as variations of the particular embodiments may be made and still fall within the scope of the appended claims. It is also to be understood that the terminology employed is for the purpose of describing particular embodiments, and is not intended to be limiting. Instead, the scope of the present invention will be established by the appended claims.

In this specification and the appended claims, the singular forms “a,” “an,” and “the” include plural reference unless the context clearly dictates otherwise. Unless defined otherwise, all technical and scientific terms used herein have the same meaning as commonly understood to one of ordinary skill in the art to which this invention belongs.

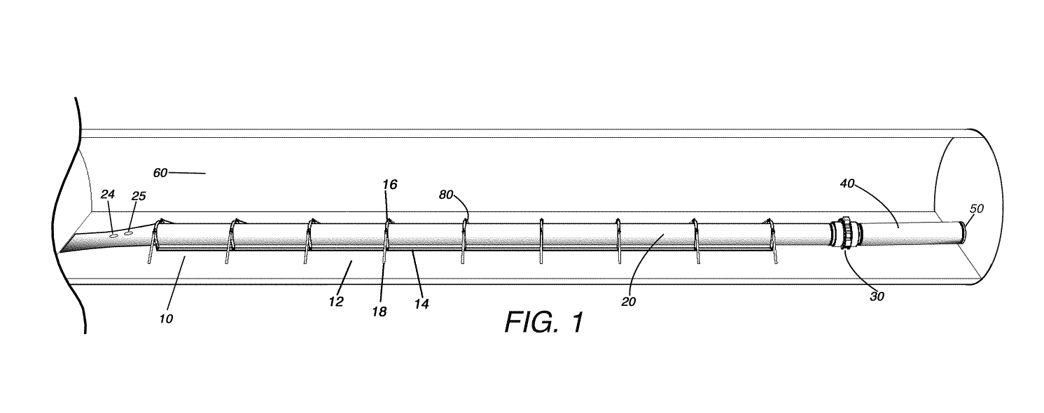

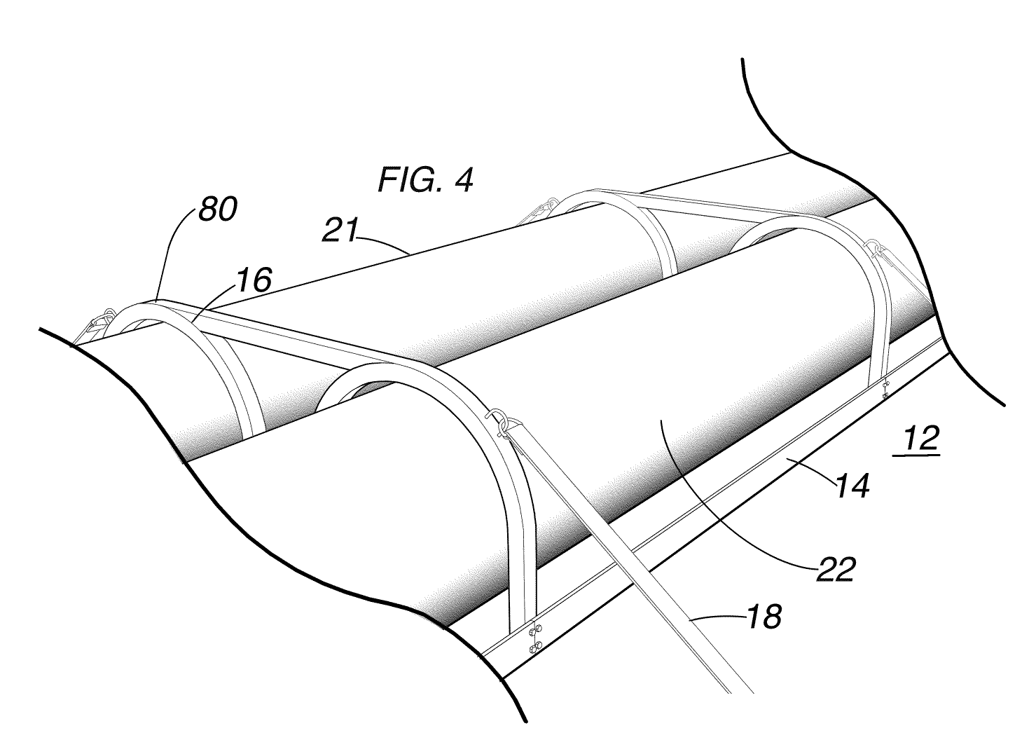

Referring now to the drawings, and in particular FIG. 1, the aircraft liquid dispensing device 10, is filled with liquid and generally designated by the reference numeral 10. Aircraft liquid dispensing device 10 is generally comprised of a flexible and collapsible fluid reservoir 20 constructed from fluid impervious material such as polyurethane coated polyester or similarly suitable materials used for similar purposes, liquid control valve 30 which can be manually or remotely operated, liquid discharge tube 40, outlet orifice 50, first fill port 24, and second fill port 25. Both fill ports 24, 25 enable the reservoir 20 to be filled with liquid, and are closed once the reservoir 20 is filled to the desired capacity. Fill ports 24, 25 are optionally located on a first end of the reservoir 20 which is opposite the liquid control valve 30 at a second end of the reservoir 20, but it should be understood that fill ports 24, 25 may be located anywhere along the reservoir 20, including near the liquid control valve 30. The liquid dispensing device 10 is positioned inside the pressurized interior of the airplane 60, and is secured to the airplane 60 by a reservoir restraint assembly 80 comprising frame 14 which includes a plurality of brackets 16. The frame 14 can be secured to the floor 12 of the airplane 60 by straps 18 which are connected between the brackets 16 and the floor 12, the assembly of which is shown in more detail in FIG. 4 with respect to a double-reservoir arrangement described below. Preferably, the brackets 16 are shaped to conform generally to the shape of the reservoir 20 when it is full of the liquid to be dispensed. The reservoir restraint assembly 80 is preferably constructed from any material providing sufficient strength and rigidity to secure the reservoir 20 in a full condition during flight.

The reservoir 20 is capable of storing therein a fire extinguishing agent or oil spill dispersant. The liquid control valve 30 meters the flow of liquids from the reservoir 20 into the discharge tube 40, and then dispenses the liquids from the airplane through outlet orifice 50. Importantly, the reservoir 20 is adapted to collapse and release liquids contained therein responsive to a pressure differential between the aircraft 60 interior and outside the aircraft 60.

The fire-extinguishing agent may include water, a liquid fire retardant chemical, or other chemical compositions which are designed to extinguish a fire. Similarly, the oil spill dispersant may include soapy type chemicals used to dissolve oil slicks, such as those manufactured by Nalco Holding Company and marketed under the trademark Corexit.

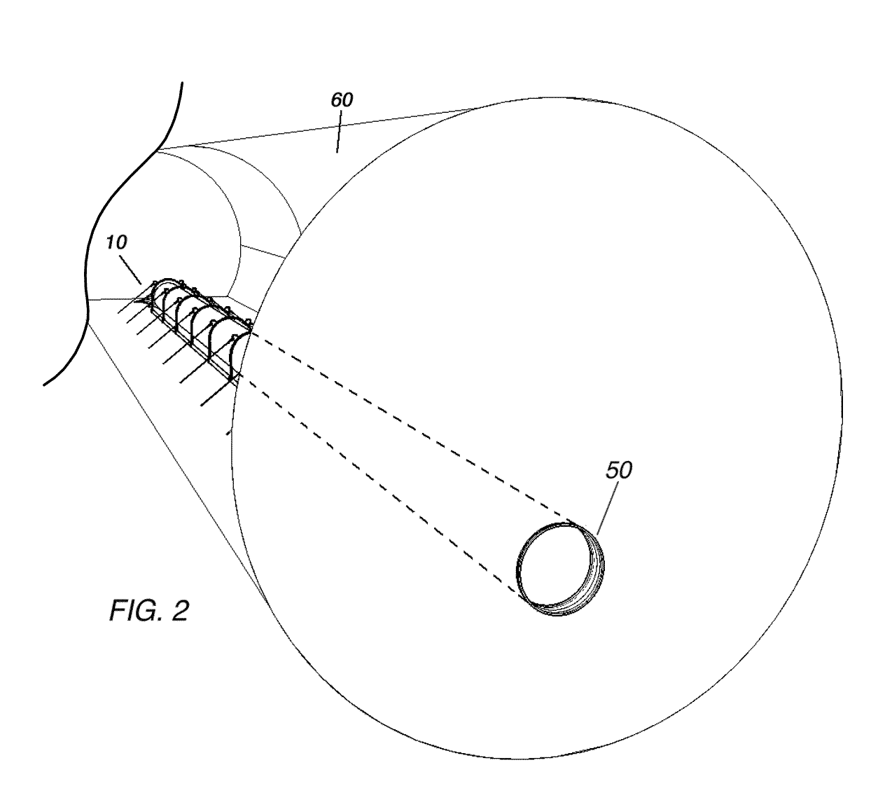

Referring now to FIG. 2, the outlet orifice 50 is attached to the skin of the aircraft with any suitable air tight connection understood to those of ordinary skill in the art.

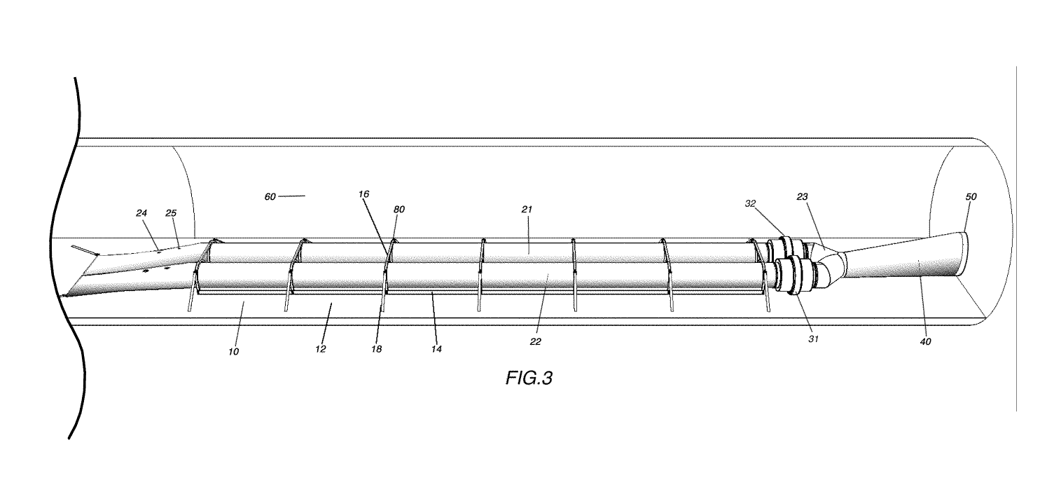

Referring now to FIG. 3 an alternate embodiment of the invention includes multiple flexible and collapsible fluid reservoirs 21, 22, a dispensing manifold 23 that fluidically connects the two reservoirs, two liquid control valves 31, 32 between the manifold 23 and the reservoirs 21, 22, liquid discharge tube 40, and outlet orifice 50. Referring also to FIG. 4, the reservoir restraint system 80 is shown in greater detail installed around the flexible and collapsible fluid reservoirs 21, 22.

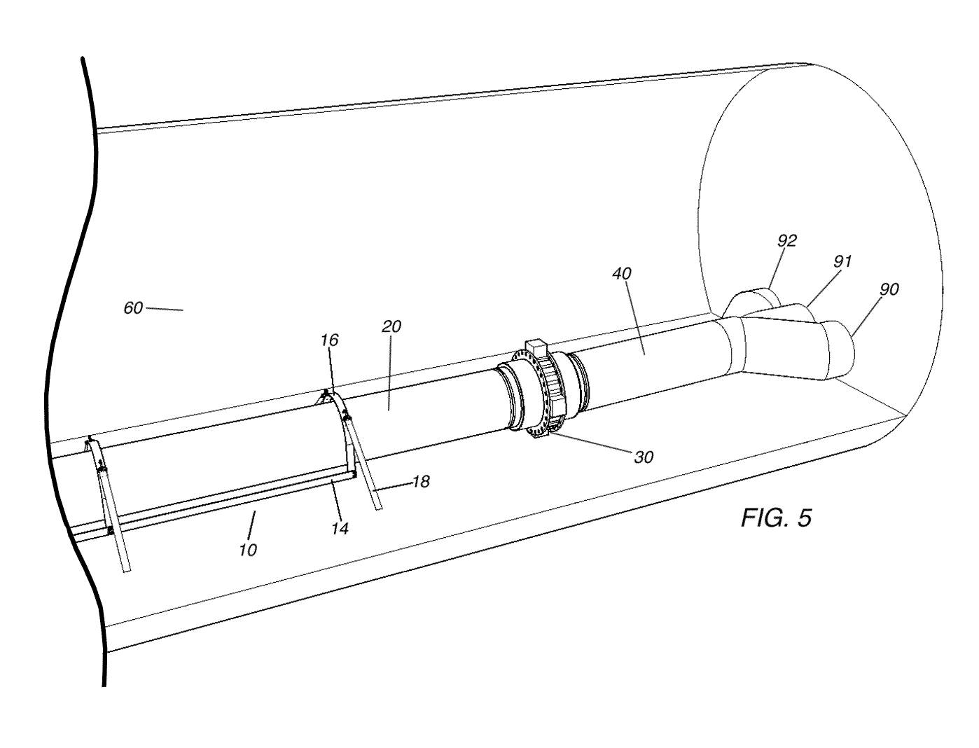

Referring now to FIG. 5, a further alternative embodiment of the present invention is shown wherein the output of a single reservoir 20 is diverted through multiple outlet orifices 90, 91, 92 which are attached to the outer skin of the airplane 60 with an air tight connection.

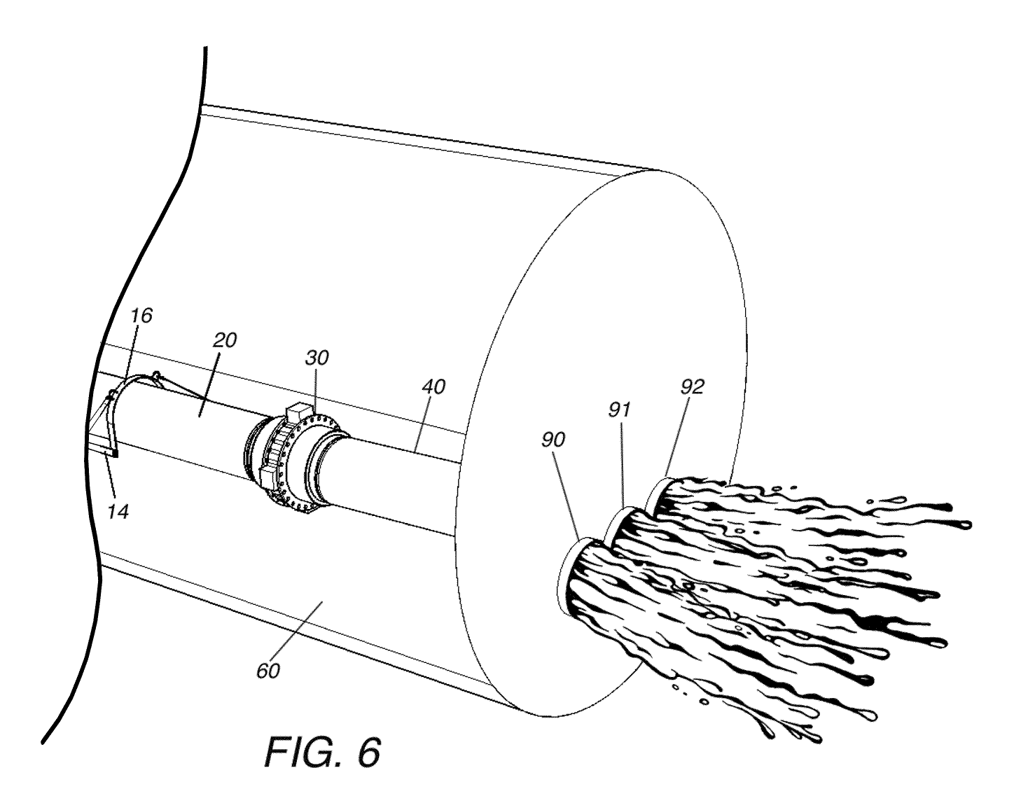

Referring also to FIG. 6, an exterior view of the airplane 60 is shown with the dispensing device 10 in the embodiment of FIG. 5 in an operable position inside the pressurized interior of the airplane 60. The outlet orifices 90, 91, 92 are shown dispensing the liquid as the reservoir 20 begins to collapse as it empties due to the pressure differential as described above.

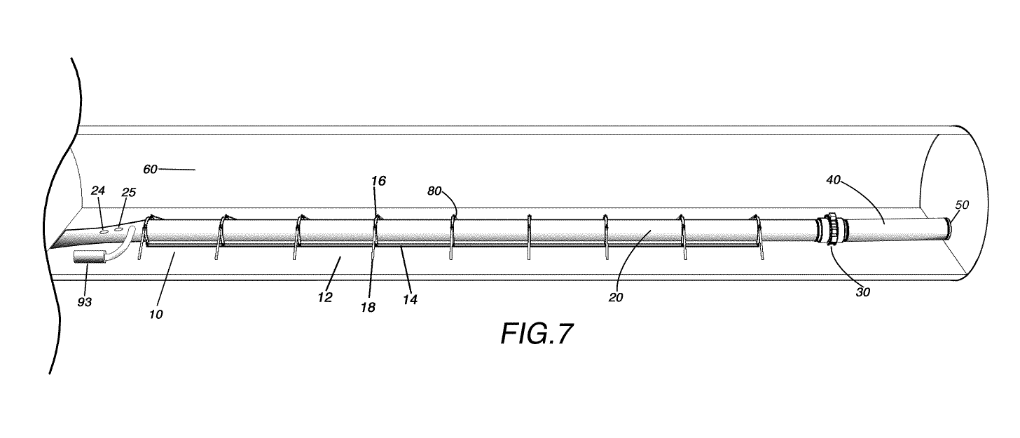

Finally, and referring also to FIG. 7, the liquid dispensing device 10 of FIG. 1 is shown in its full condition, but also including pump 93. Pump 93 optionally supplies additional air pressure to the reservoir 20 above, or in addition to, what may already exist as a natural pressure differential between the cabin pressure and external to the airplane 60. Thus, if the operator believes that the natural pressure differential based on altitude of the airplane 60 is inadequate, the pump 93 may easily be deployed to increase the pressure within the reservoir 20 to increase the rate that the contents are released from the airplane 60. Once the contents of the reservoir 20 have been dispensed, the device 10 may be dismantled in the normal course. Alternatively, the device 10 may be refilled via ports 24, 25 after closing valve 30 for another dispensing operation.

All references cited in this specification are herein incorporated by reference as though each reference was specifically and individually indicated to be incorporated by reference. The citation of any reference is for its disclosure prior to the filing date and should not be construed as an admission that the present invention is not entitled to antedate such reference by virtue of prior invention.

It will be understood that each of the elements described above, or two or more together may also find a useful application in other types of methods differing from the type described above. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention set forth in the appended claims. The foregoing embodiments are presented by way of example only; the scope of the present invention is to be limited only by the following claims.

The invention claimed is:

1. An aircraft liquid dispensing system, comprising:
(a) a flexible and collapsible reservoir positioned within a pressurized aircraft interior;
(b) a fill port located on the reservoir;
(c) a liquid control valve fluidically coupled to one end of the reservoir;
(d) a discharge tube fluidically connected between the liquid control valve and an exterior surface of the aircraft; and
wherein the reservoir is adapted to collapse and release liquids contained therein responsive to a pressure differential between the aircraft interior and outside the aircraft.

2. The dispensing system of claim 1, wherein the reservoir is secured to the aircraft by a restraint assembly.

3. The dispensing system of claim 1, comprising a plurality of reservoirs.

4. The dispensing system of claim 3, wherein the reservoirs are fluidically coupled to the discharge tube by a manifold.

5. The dispensing system of claim 1, wherein the valve is manually controlled.

6. The dispensing system of claim 1, wherein the valve is remotely controlled.

7. The dispensing system of claim 2, wherein the restraint assembly includes a frame adapted to secure the reservoir to the aircraft, and a plurality of brackets which generally conform to the shape of the reservoir in a filled condition.

8. The dispensing system of claim 1, wherein output of the discharge tube is directed through multiple ports to the exterior of the aircraft.

9. The dispensing system of claim 1, further comprising a pump fluidically coupled to the reservoir to increase the flow of liquids.
